(19) United States
(12) Patent Application Publication
(10) Pub. No.: US 2002/0094126 A1
(43) Pub. Date: Jul. 18, 2002

(54) FRACTAL IMAGE COMPRESSION

(76) Inventors: TAKAHIRO FUKUHARA, KANAGAWA (JP); AKIO OHBA, KANAGAWA (JP)

Correspondence Address: FROMMER LAWRENCE & HAUG, 745 FIFTH AVENUE- 10TH FL., NEW YORK, NY, 10151, US

(21) Appl. No.: 09/182,178

(22) Filed: Oct. 29, 1998

(30) Foreign Application Priority Data
Oct. 31, 1997 (JP) 9-301094

(51) Int. Cl. G06K 9/36

(52) U.S. Cl. 382/249

(57) ABSTRACT

An iterated image transformation and decoding apparatus and method, and a recording medium are provided. The iterated image transformation and decoding apparatus includes a transformation map analysis device for unscrambling a coded bit stream and analyzing a transformation map between two polygons; a polygon information generation device for generating information for generating one of the polygons; an image transformation and generation device for performing map transformation by using a representative map extracted by the transformation map analysis device; an image memory for storing the transformed polygonal image at the transformed position; and a control device for performing control so that the transformation and generation of the polygon is iteratively processed. Therefore, it is possible to generate a decoded image having a special reproduction effect.

### BACKGROUND OF THE INVENTION

1. Field of the Invention

The present invention relates to an iterated image transformation and decoding apparatus and method, and a recording medium. More particularly, the present invention relates to an iterated image transformation and decoding apparatus and method which, by using iterated transformation, decodes a coded bit stream output from a coder for an image provided to a system that performs low-rate-coding of an -image, or efficient transmission or storage of an image, and a recording medium.

2. Description of the Related Art As a typical conventional image compression method, the commonly called JPEG (Joint Photographic Coding Experts Group) method, which is standardized by the ISO, is known. This JPEG method uses DCT (Discrete Cosine Transform), and when a relatively high bit rate is assigned, provides a satisfactory coded/decoded image. If the number of coding bits is reduced to some degree, however, block distortion which is a characteristic of DCT becomes subjectively conspicuous, and image degradation becomes noticeable.

In addition to this, recently, an image compression method using an iterated function system (IFS) is beginning to attract attention. This method utilizes self-similarity of an image under the precondition that when a part of an image is taken out from the entire image, another image which closely resembles the taken-out image is present in the form of a different size within the image. In this iterated function system, block distortion such as that of the above-described JPEG is not conspicuous, and the self-similarity among blocks of different sizes within the image is utilized, yielding the advantage that there is no dependence upon the resolution during decoding. This iterated transformation coding is also called fractal coding, and application to various fields is expected.

The basic construction of the above-described iterated transformation coding is shown in, for example, the paper “Image coding based on a fractal theory of Iterated Contractive Image Transformations” by Arnaud E. Jacquin, IEEE Transactions on Image Processing, Vol.1, No.1, pp.18-30. The iterated transformation and coding apparatus shown therein is shown in FIG. 8, and the iterated transformation and decoding apparatus shown therein is shown in FIG. 9.

The iterated transformation and coding apparatus will be described first with reference to FIG. 8.

An original image 300 supplied to this iterated transformation and coding apparatus of FIG. 8 is input to a block generation circuit 200 where it is divided into a plurality of blocks 301. These blocks are set so as not to overlap each other. Also, reduced images 307 obtained by reducing the original image 300 by a reduced-image generation circuit 202 are stored in a reduced-image storing circuit 210. For the divided blocks 301, in an approximation area search circuit 201, reduced images are searched in a full search within the reduced-image storing circuit 210 and the reduced image that is most similar is detected from among the reduced images. Approximation block position information 306, obtained thereby, indicating which portion of the reduced image should be extracted, is transmitted to the reduced-image storing circuit 210, and a reduced image 305 of a specified area is taken out. Then, the reduced image 305 of the specified area is subjected to, for example, rotation/reverse/level-value conversion in accordance with a transformation parameter 304 in a rotation/reverse/level-value conversion section 203, and a reduced image 303 after being transformed is output. As a result, the transformation parameter 304 and the approximation block position information 306 are output as an iterated function system (IFS) code 302.

Next, a description will be given of the iterated transformation and decoding apparatus with reference to FIG. 9.

The IFS code 302 output from the iterated transformation and coding apparatus of FIG. 8 is once input to an IFS code storing circuit 205 and stored therein. The IFS code 302 is read therefrom sequentially in block units for a plurality of times. An IFS code reading circuit 206 reads an IFS code 308 in block units and separates it into the approximation block position information 306 and the transformation parameter 304. Then, the approximation block position information 306 is input to a reduced-image storing circuit 210, and the reduced image 305 of the specified area is taken out from the reduced image in accordance with the position information 306. This reduced image 305 of the specified area is subjected to a transformation process based on the transformation parameter 304 by the rotation/reverse/level-value conversion section 203, is added and copied onto the decoded image within a decoded-image storing circuit 208 and is stored. When the IFS code reading circuit 206 completes the reading of the IFS code 308 of all the blocks, the IFS code reading circuit 206 sends a reading completion notification signal 310 to a copying control circuit 207. This copying control circuit 207 measures the number of times a series of the above copying process has been performed. When the number has not reached a preset value, a re-reading instruction signal 309 is output to the IFS code reading circuit 206, and the copying process is performed again on all the blocks of the image. At the same time, re-processing instruction information is sent in accordance with a decoded-image output control signal 311, and a decoded image 313 is connected, by a switch 209, to an input 314 with respect to the reduced-image generation circuit 202. The reduced-image generation circuit 202 generates a reduced image 315 in exactly the same manner as on the coder side, and the contents of the image stored in the reduced-image storing circuit 210 are replaced with this image. When, on the other hand, the copying process has reached a preset number of times, the copying control circuit 207 issues a termination instruction in accordance with a decoded-image output control signal 311, the decoded image 313 is connected to a final output image 316 by a switch 209, and an output of the decoder is obtained.

In an example of conventional technology such as that described above, the approximation with respect to an image obtained by performing a reduction and transformation process on a block at an arbitrary place of the self entire image screen is measured. The position information of the most similar block and the transformation parameter at that time are selected from all possible candidates. As a result, in the coder, a coded code is written into the bit stream in the sequence of the coded block.

Meanwhile, in the decoder, the coded bit stream is unscrambled, and a decoded image having the same size or the same aspect ratio as that of the input image on the coder side is output.

An object of such conventional image coding and decoding is to code an input original image at the highest quality with the least amount of information as possible, and there are no functions of analyzing the features of the original image and generating an image resembling this original image by means of a decoder. Also, consideration is not given to the generation of a special image which uses a self-similarity function of an image brought about by iterated transformation coding.

### SUMMARY OF THE INVENTION

An object of the present invention, which has been achieved in view of such circumstances, is to provide an iterated image transformation and decoding apparatus and method, which has functions of unscrambling a coded bit stream and analyzing and extracting a representative map, and reconstructing various special images in accordance with this map, and a recording medium.

To achieve the above-mentioned object, according to one aspect of the present invention, there is provided an iterated image transformation and decoding apparatus comprising: transformation map analysis means for unscrambling a coded bit stream and analyzing a transformation map between two polygons; polygon information generation means for generating information for generating one of the polygons; image transformation and generation means for performing map transformation by using a representative map extracted by the transformation map analysis means; image memory means for storing the transformed polygonal image at the transformed position; and control means for performing control so that the transformation and generation of the polygon is iteratively processed.

With such a construction, the transformation map analysis means unscrambles a coded bit stream, and analyzes and extracts a transformation map between two polygons. The polygon image generation means uses the extracted polygon information in order to generate information for generating one of the polygons which is a transformation source.

According to another aspect of the present invention, there is provided an iterated image transformation and decoding apparatus comprising: bit-stream separation means for separating and unscrambling a plurality of coded bit streams; polygon/transformation map selection means for selecting the position information of a desired polygonal image and a map transformation parameter from among a plurality of kinds of obtained position information and map transformation parameters; polygonal image generation means for generating information for generating one of the polygons; image transformation and generation means for performing map transformation by using the selected transformation map; an image memory for storing the transformed polygonal image at the transformed position; and control means for performing control so that the transformation and generation of the polygon is iteratively processed.

With such a construction, the bit-stream separation means separates and unscrambles a plurality of coded bit streams. The polygon/transformation map selection means selects the position information of a desired polygonal image and a map transformation parameter from among a plurality of kinds of obtained position information and map transformation parameters.

The above and further objects, aspects and novel features of the invention will become more apparent from the following detailed description when read in connection with the accompanying drawings.

### BRIEF DESCRIPTION OF THE DRAWINGS

FIG. 1 is a block diagram schematically showing the construction of an iterated image transformation and decoding apparatus of an aspect-ratio variable type, which is a first embodiment of the present invention.

FIG. 2 shows the distribution of a map of contrast and brightness, which are luminance components of an image.

FIG. 3 shows an example of an image which is decoded by using a representative transformation parameter according to the first embodiment of the present invention.

FIG. 4 is a block diagram schematically showing the construction of an iterated transformation and coding apparatus corresponding to the iterated transformation and decoding apparatus of FIG. 1.

FIG. 5 shows map transformation between a domain block and a range block.

FIG. 6 is a block diagram schematically showing the construction of an iterated transformation and decoding apparatus of a constructed-image deformation type, which is a second embodiment of the present invention.

FIG. 7 shows an example of an image such that a plurality of maps are selected and decoded.

FIG. 8 is a block diagram showing an example of the construction of a conventional iterated image transformation and coding apparatus.

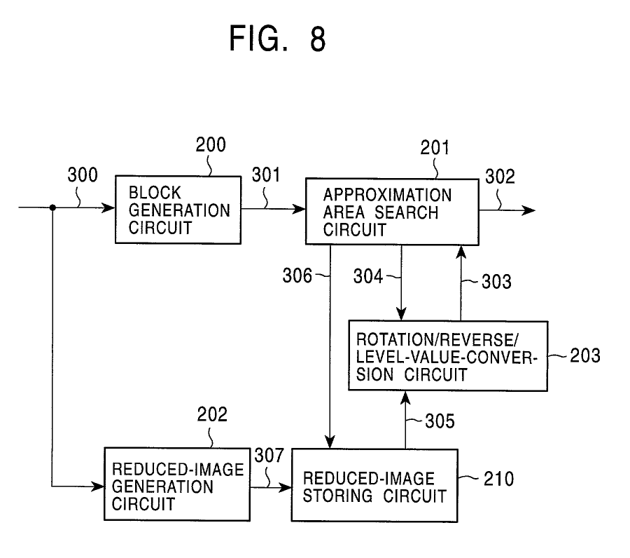

FIG. 9 is a block diagram showing an example of the construction of a conventional iterated image transformation and decoding apparatus.

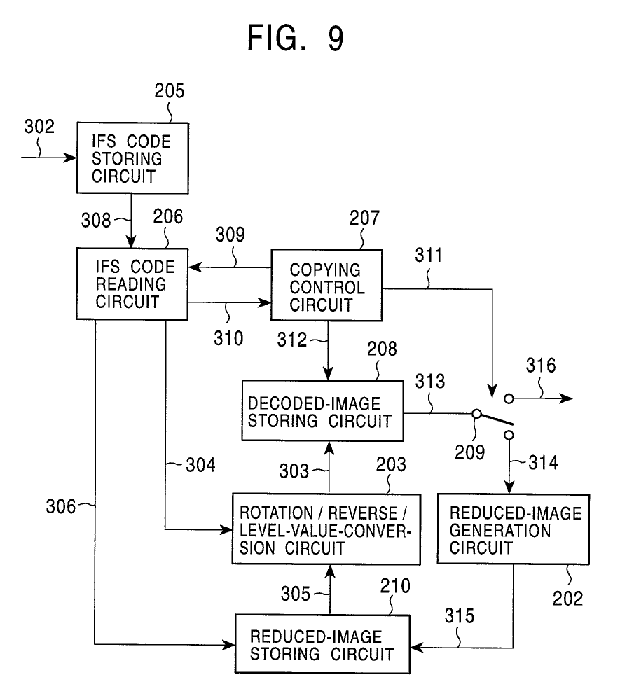

### DESCRIPTION OF THE PREFERRED EMBODIMENTS

A description will be given below of embodiments of the present invention with reference to the accompanying drawings.

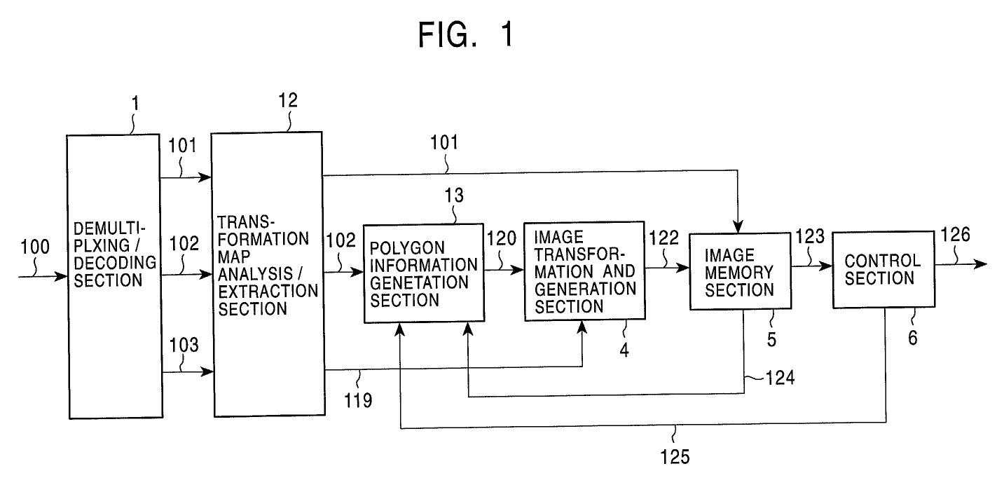

FIG. 1 is a block diagram schematically showing the construction of an iterated image transformation and decoding apparatus of a representative map reconstruction type, which is a first embodiment of the present invention.

This iterated image transformation and decoding apparatus shown in FIG. 1 comprises a transformation map analysis and extraction section 12 for unscrambling an input coded bit stream and analyzing a transformation map between two polygons; a polygon information generation section 13 for generating information for generating one of the polygons; an image transformation and generation section 4 for converting the pixel value of the image within the polygon and the position of the polygon by using a representative map extracted by the transformation map analysis and extraction section 12; an image memory section 5 for storing the transformed polygonal image at the transformed position; and a control section 6 for performing control so that the map transformation and generation of the polygon is iteratively processed.

Next, the operation thereof will be described.

In FIG. 1, a coded bit stream 100 is demultiplexed by the demultiplexing/decoding section 1, and each of the demultiplexed coded codes is decoded as required in order to reconstruct the original information. When the coded bit stream 100 is data which is not multiplexed, it is a matter of course that the demultiplexing/decoding section 1 can be omitted. However, in view of data transmission efficiency, the demultiplexing/decoding section 1 is often used.

The demultiplexing/decoding section 1 separates and decodes the number or address 101 of the first polygonal image, the number or address 102 of the second polygonal image, and the transformation parameter 103, and sends them to the transformation map analysis and extraction section 12. The transformation map analysis and extraction section 12 extracts a representative transformation parameter 119 from all the transformation parameter, and the numbers or addresses of the first polygonal image and the second polygonal image. At the same time, the image at the position of the second polygonal image indicated by the number or address 102 of the second polygonal image is read from the image memory section 5, and a polygonal image 124 and the number or address 102 of the second polygonal image are output as generated polygon information 120 to the image transformation and generation section 4. A polygonal image which is mapping-transformed by the image transformation and generation section 4 is written into the position of the number or address 101 of the first polygonal image within the image memory section 5. When the decoding of the polygonal image of a part or the entirety of the coded bit stream 100 is completed, a decoded image 123 is output from the image memory section 5 to the control section 6. The control section 6, which is at the terminus of the iterated decoding loop, performs control of the decoding loop. Therefore, when the decoding loop is performed again by the control section 6, a control signal 125 is output to the polygon information generation section 13, so that the decoding is continued. Iterated transformation decoding is performed by such decoding loop control in the control section 6 until a final decoded image 126 is output.

In this embodiment, since the transformation parameter used in the image transformation and generation section 4 is only the representative transformation parameter 119 extracted by the transformation map analysis and extraction section 12, the decoded image is different from the input image on the coder side.

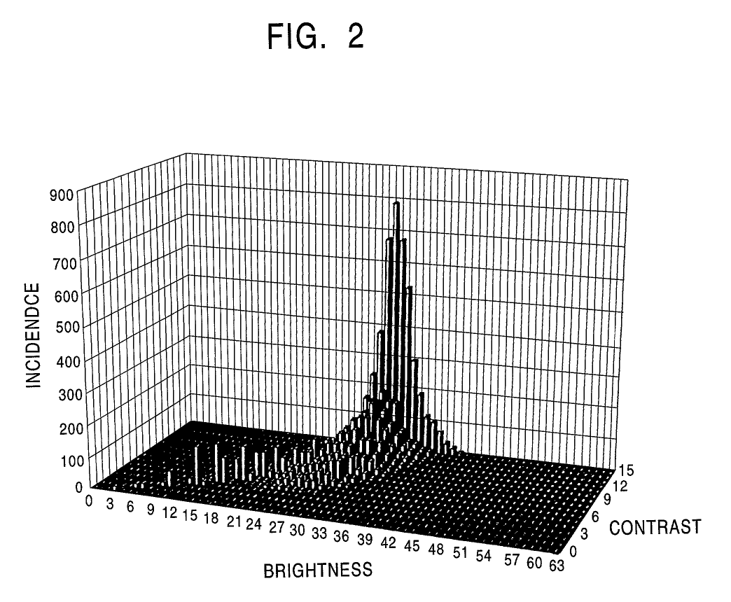

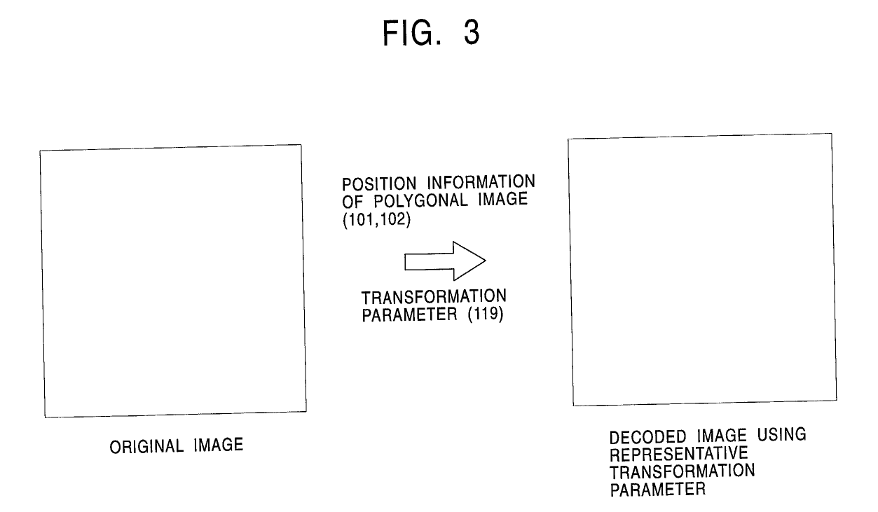

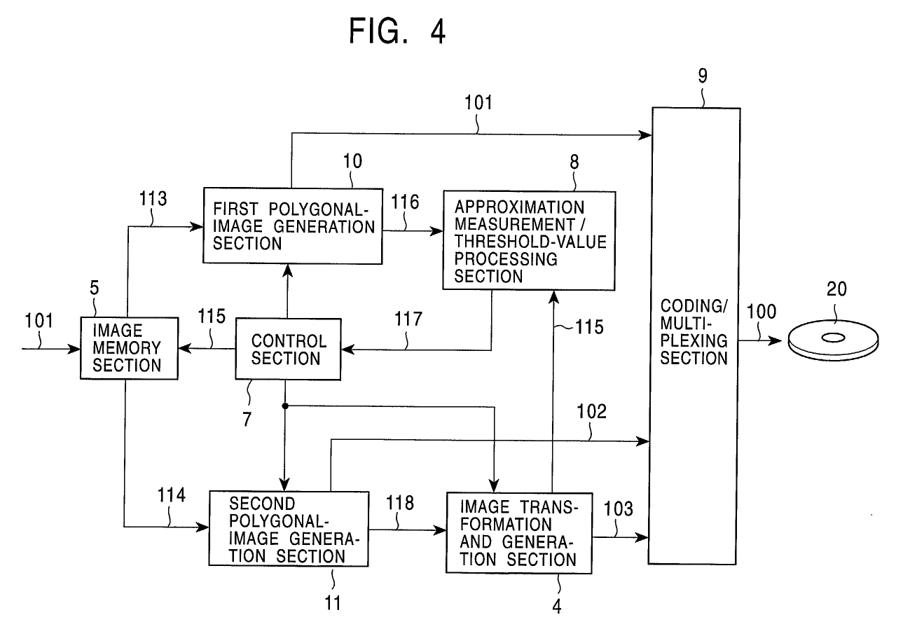

FIG. 2 is a distribution diagram (contrast, brightness) of a map having luminance components of a transformation parameter. It can be seen from this figure that the distribution of the contrast and brightness values vary greatly. Therefore, the number of representative values of the transformation parameters (c, b) is determined to be one or a limited number, and this is determined to be the representative transformation parameter 119. This makes it possible for the decoder to obtain a decoded image using only the representative transformation parameter 119 extracted from the plurality of transformation parameters 103, and this decoded image can be used as a specially reproduced image or the like. FIG. 3 shows a decoded image obtained by the above-mentioned technique by using the number or address 101 of the first polygonal image, the number or address 102 of the second polygonal image, and the representative transformation parameter 119, and the original image. Next, FIG. 4 shows an example of the construction of an iterated transformation and coding apparatus corresponding to the image transformation decoding apparatus of the above-described first embodiment shown in FIG. 1.

This iterated image transformation and coding apparatus shown in FIG. 4 comprises an image memory section 5, a control section 7, a first polygonal-image generation section 10, a second polygonal-image generation section 11, an image transformation and generation section 4, an approximation measurement/threshold-value processing section 8, and a coding/multiplexing section 9.

In FIG. 4, the input original image 101 is first sent out to the image memory section 5. A first image 113 read from the image memory section 5 is sent out to the first polygonal-image generation section 10, and a second image 114 is sent to the second polygonal-image generation section 11. In each of the polygonal-image generation sections 10 and 11, each image is divided into a plurality of polygonal images which form the image screen. Here, the second polygonal-image generation section 11 divides the entire image screen into a plurality of polygonal images of a specific size before a polygonal-image generation operation in the first polygonal-image generation section 10 is performed. The generated second polygonal-image information (number or address) 102 is sent to the coding/multiplexing section 9. This series of operations is continued on all the polygonal images which constitute one image screen.

After the above operation is terminated, in the first polygonal-image generation section 10, polygonal images are read in sequence (ordinarily, in the direction from the upper left of the image screen to the lower right) from the image screen of the image memory section 5, and the first read polygonal image is sent to the approximation measurement/threshold-value processing section 8. A polygonal image 118 is read by, for example, a full search, from the image memory section 5 through the second polygonal-image generation section 11. A predetermined transformation process, such as rotation/translation/enlargement/reduction, etc., is performed on the obtained second polygonal image 118 by the image transformation and generation section 4, and a transformed polygonal image 115 is output to the approximation measurement/threshold-value processing section 8. A specific example of the transformation process at this time will be described later in detail. In the approximation measurement/threshold-value processing section 8, matching between the first polygonal image 116 and the transformed polygonal image 115 is obtained, and a polygonal image such that the error between them is minimized is searched and selected. The polygonal-image information 102, such as the number of polygonal images or the address obtained at this time, and the transformation parameter 103 are each coded (for example, Huffman-coded) by the coding/multiplexing section 9, and then the obtained codeword is multiplexed and sent out as the output of the coder. This multiplexed codeword is transmitted through a transmission medium, such as a communication line, or is recorded on a recording medium 20, such as an optical disk or a magnetic disk, and is distributed.

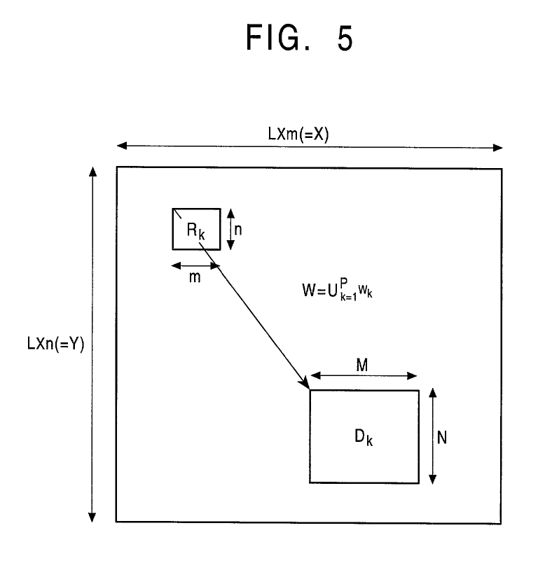

Referring to FIG. 5, a description will now be given of the basic theory of iterated transformation and coding/decoding, which is a basic technique of an embodiment of the present invention.

The iterated transformation and coding is, in general, a technique for performing image coding by iteratively performing reduction mapping from a domain block to a range block with respect to all the range blocks which constitute the image screen. At this time, the position information of the domain block and the transformation parameter which approximates each range block most closely are coded.

In FIG. 5, a range block Rₖ corresponds to the first polygonal-image information 104 (or 101 ). Although it is generally a polygon, here, a rectangular block is used as an example for the purpose of simplifying the figure. Similarly, a domain block Dₖ corresponds to the second polygonal-image information 105 (or 102 ), and a rectangular block is also used as an example. Here, the block size of Rₖ is set at m×x, and the block size of Dₖ is set at M×N. FIG. 5 shows that there are L×L range blocks. The block size of the range block and the domain block are factors which greatly affect coding efficiency, and this size determination is important.

A block image transformation by the image transformation/generation section 4 is a transformation from Dₖ to Rₖ. If the mapping function into the block Rₖ is denoted as wₖ and the number of domain blocks required to mapping-transform the entire image screen is denoted as P, the image f is mapped as follows by a mapping function W for the entire image:

W(f)=W₁(f)∪W₂(f)∪. . . ∪Wₚ(f) (1)

Therefore, W is expressed by the equation below.

W=∪^{p}ₖ₌₁wₖ (2)

Here, for the mapping function W, any may be selected as long as it is converged. To ensure convergence, generally, reduction mapping is often used. Furthermore, affine transformation is often used for simplicity of processing. The case in which Dₖ is mapped into Rₖ by affine transformation is formed into a mathematical expression by denoting an actual transformation function as vᵢ as described below:

$${v}_{i} ( x , y ) = [ \begin{matrix}{a}_{i} {b}_{i} \\ {c}_{i} {d}_{i}\end{matrix} ] [ \begin{matrix}x \\ y\end{matrix} ] + [ \begin{matrix}{e}_{i} \\ {f}_{i}\end{matrix} ] \qquad ( 3 )$$

This equation (3) make it possible to express all transformations, such as rotation/translation/enlargement/reduction, etc., between two blocks.

Although the above-described example shows transformation for space coordinates of a block, the pixel values, for example, the density values, such as luminance or color-difference information, can be mapping-transformed by using affine transformation in a similar manner. In this case, for example, for the sake of simplicity, a relation that a pixel value dᵢ within Dₖ is mapped into a pixel value rᵢ of Rₖ is expressed as the equation below:

vⱼ(dᵢ)=s×dᵢ+o (4)

where s can be defined as contrast, and o as an offset value. In this case, the parameters s and o may be computed so that the differential square sum of the error with respect to the pixel value rᵢ within Rₖ is minimized. That is, these may be set so that the following is satisfied:

Σ(s×dᵢ+o −rᵢ)²→minimum value (5)

The image transformation/generation section 4 has contained therein a circuit for performing transformation, such as rotation/translation/enlargement/reduction, etc., shown, for example, in equation (3), and performs position transformation within the image screen onto the second polygonal-image information 105 read from the image memory section 5. FIG. 5 shows a state in which Dₖ, which was in the lower right of the screen, is mapping-transformed into Rₖ in the upper left of the screen.

Next, as a method for converting the density value of the pixel within the block, this too can be realized by using affine transformation. By performing transformation processes on the second read polygonal-image information 105 by changing the transformation coefficients (aᵢ, bᵢ, cᵢ, dᵢ, eᵢ, fᵢ) of equation (3) above in various ways, a polygonal image 106 after being transformed can be obtained.

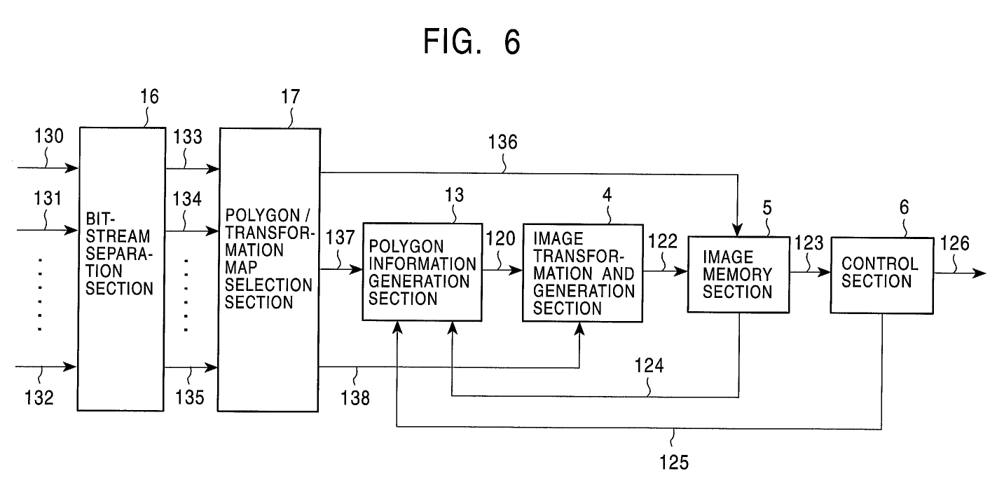

Next, referring to FIG. 6, a description will be given of an iterated image transformation and decoding apparatus, which is a second embodiment of the present invention.

FIG. 6 is a block diagram schematically showing the construction of an iterated transformation and decoding apparatus, which is a second embodiment. This iterated transformation and decoding apparatus shown in FIG. 6 comprises a bit-stream separation section 16 for unscrambling and analyzing a plurality of input coded bit streams; a polygon/transformation map selection section 17 for selecting the position information of a desired polygonal image and a map transformation parameter from among a plurality of kinds of obtained position information between polygons and map transformation parameters; a polygon information generation section 13 for generating information for generating one of the polygons; an image transformation and generation section 4; an image memory section 5 for storing the transformed polygon at the transformed position; and a control section 6 for performing control so that the transformation and generation of the polygon is iteratively processed.

Next, a description will be given of the operation thereof.

The bit-stream separation section 16 inputs a plurality of coded bit streams and separates and unscrambles these streams. In this embodiment, n coded bit streams from the first coded bit stream 130 to the n-th coded bit stream 132 are used as an input signal. As a result, n position information of polygons, corresponding to the n coded bit streams, and information 133 to 135 of a transformation parameter group, are output separately from the bit-stream -separation section 16. In the first embodiment, the position information of a polygon means the number or address 101 of the first polygonal image and the number or address 102 of the second polygonal image, and the transformation parameter designates 103. The polygon/transformation map selection section 17 receiving input signals of the position information of the first polygon and the transformation parameter group 133 to the position information of the n-th polygon and the transformation parameter group 135, output from the bit-stream separation section 16, selects the position information of a certain polygonal image and a map transformation parameter from among a plurality of kinds of obtained position information among polygons and map transformation parameters. As a result, the selected polygonal image information 136 of the transformation target, the selected polygonal image information 137 of the transformation source, and the selected transformation parameter 138 are output from the polygon/transformation map selection section 17. The procedure of decoding loop control using map transformation between two different polygonal images (the polygonal image of the transformation source, and the polygonal image of the transformation target) may be the same as the method which has already been described.

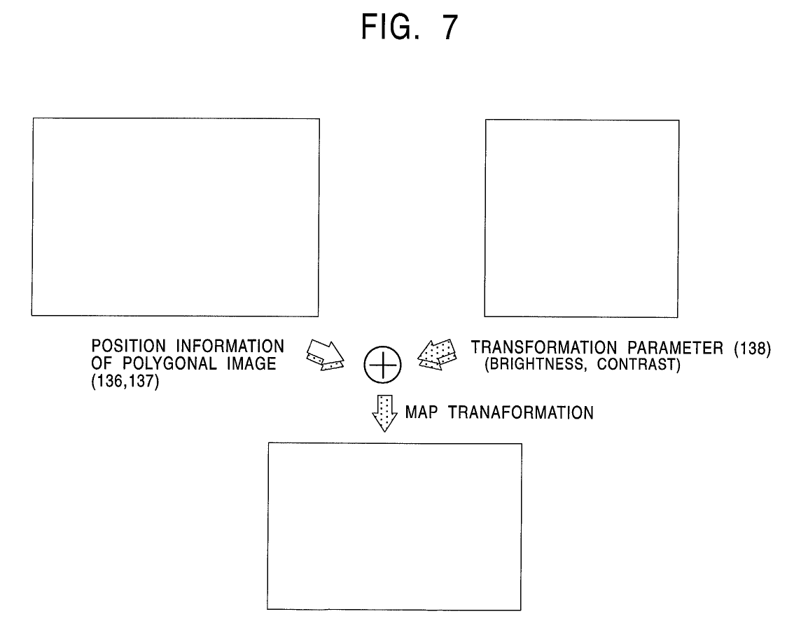

FIG. 7 shows an example in which iterated transformation decoding is performed by using the polygonal image information which is selected actually and the similarly selected transformation parameter.

In FIG. 7, the upper two original images are coded to generate a coded bit stream first. Position information 136 and 137 of a polygon are selected and output by the polygon/transformation map selection section 17 from the position information of the first polygon, extracted by the bit-stream separation section 16 from the coded bit stream (corresponds to 130 ) of the original image in the upper left, and the transformation parameter group 133. On the other hand, a transformation parameter 138 is selected and output by the polygon/transformation map selection section 17 from the position information of the second polygon, extracted by the bit-stream separation section 16 from the coded bit stream (corresponds to 131 ) of the original image in the upper right, and the transformation parameter group 134. In this case, as described in the first embodiment, forming the transformation parameter from contrast and brightness is easy. As a result of the above operations, the position information 136 and 137 of polygonal images, required for decoding, are extracted from the coded bit stream of one of the images, and the transformation parameter 138 is extracted from the coded bit stream of the other image. This makes it possible to realize iterated transformation decoding of a special reproduction and reconstruction type, which is capable of obtaining a synthesized image having features of two or more different images.

Furthermore, the above-described iterated image transformation and decoding apparatus and method can be realized by means of software, and a recording medium in which programs for realization thereof are recorded can be provided.

More specifically, there can be provided a recording medium in which is recorded a program for executing: a transformation map analysis step for unscrambling a coded bit stream and analyzing a transformation map between two polygons; a polygon information generation step for generating information for generating one of the polygons; an image transformation and generation step for converting the pixel value of the image within the polygon and the position of the polygon by using a representative map extracted by the transformation map analysis step; a step for storing the transformed polygonal image at the transformed position of the image memory section; and a control step for performing control so that the transformation and generation of the polygon is iteratively processed.

Furthermore, there can be provided a recording medium in which is recorded a program for executing: a bit-stream separation step for separating and unscrambling a plurality of input coded bit streams; a polygon/transformation map selection step for selecting the position information of a desired polygonal image and a map transformation parameter from among a plurality of kinds of obtained position information and map transformation parameters; a polygonal image generation step of generating information for generating one of the polygons; an image transformation and generation step for converting the pixel value of the image within the polygon and the position of the polygon by using the selected transformation map; a step for storing the transformed polygonal image at the transformed position of the image memory means; an a control step for performing control so that the transformation and generation of the polygon is iteratively processed.

It is a matter of course that besides being recorded in recording media and distributed, these programs can also be distributed via telephone lines, communication networks, etc.

Specific application examples of the iterated image transformation and coding apparatus and decoding apparatus, such as those described above, include digital video disks, image databases, image compression/decompression units for the purpose of downloading images over the Internet, or software modules in which the iterated image transformation and coding and decoding method is realized.

According to the present invention, an input coded bit stream is unscrambled to analyze and extract a transformation map between two polygons, and information for generating one of the polygons, which is a transformation source, is generated by using the extracted representative map, making it possible to generate a decoded image having a special reproduction effect, which is different from a decoded image, by a conventional decoder which faithfully reconstructs an original image.

Furthermore, a plurality of coded bit streams are separated and unscrambled, the position information of a desired polygonal image and a map transformation parameter are selected from among a plurality of kinds of obtained position information between polygons and map transformation parameters, and the pixel value of the image within the polygon and the position of the polygon are converted by using the selected transformation map. Therefore, unlike a conventional decoder which faithfully reconstructs an original image, by selecting a map extracted from coded bit streams of a plurality of images, a special image having representative features of a plurality of images, that is, having the features of two or more different images, can be decoded and generated.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

What is claimed is:

1. An iterated image transformation and decoding apparatus, comprising:
transformation map analysis means for unscrambling an input coded bit stream and analyzing a transformation map between two polygons;
polygon information generation means for generating information for generating one of the polygons;
image transformation and generation means for performing map transformation by using a representative map extracted by said transformation map analysis means;
an image memory for storing the transformed polygonal image at the transformed position; and
control means for performing control so that the map transformation and generation of said polygon is iteratively processed.

2. An iterated image transformation and decoding apparatus according to claim 1, wherein said transformation map analysis means analyzes a transformation map between two polygons and extracts a representative transformation parameter from among a plurality of kinds of obtained transformation parameters.

3. An iterated image transformation and decoding apparatus according to claim 1, wherein said image transformation and generation means has contained therein affine transformation means for performing a series of transformation processes including at least one of rotation, translation, reduction, and enlargement.

4. An iterated image transformation and decoding apparatus according to claim 1, wherein said image transformation and decoding apparatus converts the pixel value of an image within a polygon and the position of the polygon.

5. An iterated image transformation and decoding apparatus according to claim 1, wherein said image memory overwrites the polygonal image transformed by said image transformation and generation means onto an image held previously and stores it each time the map transformation and generation is iteratively processed.

6. An iterated image transformation and decoding method, comprising the steps of:
a transformation map analysis step for unscrambling a coded bit stream and analyzing a transformation map between two polygons;
a polygon information generation step for generating information for generating one of the polygons;
an image transformation and generation step for performing map transformation by using a representative map extracted in said transformation map analysis step;
a step for storing the transformed polygonal image at the transformed position of the image memory; and
a control step for performing control so that the transformation and generation of said polygon is iteratively processed.

7. An iterated image transformation and decoding method according to claim 6, wherein said transformation map analysis step analyzes a transformation map between two polygons and extracts a representative transformation parameter from among a plurality of kinds of obtained transformation parameters.

8. An iterated image transformation and decoding step according to claim 6, wherein said image transformation and generation step has contained therein affine transformation means for performing a series of transformation processes including at least one of rotation, translation, reduction, and enlargement.

9. An iterated image transformation and decoding method according to claim 6, wherein said image transformation and decoding step converts the pixel value of an image within a polygon and the position of the polygon.

10. An iterated image transformation and decoding apparatus according to claim 6, wherein said image memory overwrites a polygonal image transformed by said image transformation and generation step onto an image held previously and stores it each time the map transformation and generation is iteratively processed.

11. An iterated image transformation and decoding apparatus, comprising:
bit-stream separation means for separating and unscrambling a plurality of input coded bit streams;
polygon/transformation map selection means for selecting the position information of a desired polygonal image and a map transformation parameter from among a plurality of kinds of obtained position information and map transformation parameters;
polygonal image generation means for generating information for generating one of the polygons;
image transformation and generation means for performing map transformation by using the selected transformation map;
an image memory for storing the transformed polygonal image at the transformed position; and
control means for performing control so that the transformation and generation of said polygon is iteratively processed.

12. An iterated image transformation and decoding apparatus according to claim 11, wherein said transformation map analysis means analyzes a transformation map between two polygons and extracts a representative transformation parameter from among a plurality of kinds of obtained transformation parameters.

13. An iterated image transformation and decoding apparatus according to claim 11, wherein said image transformation and generation means has contained therein affine transformation means for performing a series of transformation processes including at least one of rotation, translation, reduction, and enlargement.

14. An iterated image transformation and decoding apparatus according to claim 11, wherein said image transformation and decoding means converts the pixel value of an image within a polygon and the position of the polygon.

15. An iterated image transformation and decoding apparatus according to claim 11, wherein said image memory overwrites a polygonal image transformed by said image transformation and generation means onto an image held previously and stores it each time the map transformation and generation is iteratively processed.

16. An iterated image transformation and decoding method, comprising:
a bit-stream separation step for separating and unscrambling a plurality of input coded bit streams;
a polygon/transformation map selection step for selecting the position information of a desired polygonal image and a map transformation parameter from among a plurality of kinds of obtained position information and map transformation parameters;
a polygonal image generation step of generating information for generating one of the polygons;
an image transformation and generation step for performing map transformation by using the selected transformation map;
a step for storing the transformed polygonal image at the transformed position of the image memory; and
a control step for performing control so that the transformation and generation of said polygon is iteratively processed.

17. An iterated image transformation and decoding method according to claim 16, wherein said transformation map analysis step analyzes a transformation map between two polygons and extracts a representative transformation parameter from among a plurality of kinds of obtained transformation parameters.

18. An iterated image transformation and decoding method according to claim 16, wherein said image transformation and generation step has contained therein affine transformation means for performing a series of transformation processes including at least one of rotation, translation, reduction, and enlargement.

19. An iterated image transformation and decoding method according to claim 16, wherein said image transformation and decoding step converts the pixel value of an image within a polygon and the position of the polygon.

20. An iterated image transformation and decoding apparatus according to claim 16, wherein said image memory overwrites a polygonal image transformed by said image transformation and generation step onto an image held previously and stores it each time the map transformation and generation is iteratively processed.

21. A recording medium in which is recorded a program for executing:
a transformation map analysis step for unscrambling an input coded bit stream and analyzing a transformation map between two polygons;
a polygon information generation step for generating information for generating one of the polygons;
an image transformation and generation step for performing map transformation by using a representative map extracted in said transformation map analysis step;
a step for storing the transformed polygonal image at the transformed position of the image memory section; and
a control step for performing control so that the transformation and generation of said polygon is iteratively processed.

22. A recording medium in which is recorded a program for executing:
a bit-stream separation step for separating and unscrambling a plurality of input coded bit streams;
a polygon/transformation map selection step for selecting the position information of a desired polygonal image and a map transformation parameter from among a plurality of kinds of obtained position information and map transformation parameters;
a polygonal image generation step of generating information for generating one of the polygons;
an image transformation and generation step for performing map transformation by using the selected transformation map;
a step for storing the transformed polygonal image at the transformed position of the image memory means; and
a control step for performing control so that the transformation and generation of said polygon is iteratively processed.
